(19) United States
(12) Patent Application Publication
(10) Pub. No.: US 2004/0255853 A1
(43) Pub. Date: Dec. 23, 2004

(54) PECVD reactor in-situ monitoring system

(75) Inventors: Eugene Yi-Shan Ma, Chestnut Hill, MA (US); Ming Wu, Arlington, MA (US)

Correspondence Address: WILMER CUTLER PICKERING HALE AND DORR LLP, 60 STATE STREET, BOSTON, MA, 02109, US

(73) Assignee: Aegis Semiconductor, Woburn, MA

(21) Appl. No.: 10/846,991

(22) Filed: May 14, 2004

Related U.S. Application Data
(60) Provisional application No. 60/470,608, filed on May 15, 2003.

(51) Int. Cl. G01N 21/00

(52) U.S. Cl. 118/712

(57) ABSTRACT

An apparatus for depositing films on a substrate, the apparatus including: a plasma deposition chamber having a first electrode and a second electrode that defines a target plane in which the substrate is held during deposition, and wherein during deposition a plasma is sustained between the first and second electrodes, said deposition chamber also including an input window and an output window; and a monitoring system which includes a light source and an optical detector, both located outside of the deposition chamber, said optical monitoring system also including an optical system that directs a beam from the light source through the input window and into the deposition chamber as a measurement beam, wherein the measurement beam arrives at the target plane along a path that is approximately normal to the target plane and wherein during operation said measurement beam interacts with the substrate to generate a return measurement beam that passes from the substrate out of the chamber through the output window, wherein said optical system directs the measurement return beam onto the optical detector.

### CROSS-REFERENCE TO RELATED APPLICATIONS

This application claims benefit of U.S. Provisional Application Ser. No. 60/470,608, filed on May 15, 2003, entitled “PECVD In-Situ Monitoring System,” which is incorporated herein by reference.

### TECHNICAL FIELD

This invention relates to in-situ monitoring of thin film growth.

### BACKGROUND

A new category of optical filter has been designed. This new optical filter is thermo-optically tunable and constructed of multiple thin films to produce one or more Fabry-Perot cavities, which function as an optical interference filter. These filters have been fabricated in a plasma enhanced chemical vapor deposition (“PECVD”) reactor, by changing the gas compositions that enter the reactor at precise times in order to form the thin-film layers with precisely controlled thicknesses. They are described in U.S. Ser. No. 10/174,503, filed Jun. 17, 2002, and U.S. Ser. No. 10/211,970, filed Aug. 2, 2002, both of which are incorporated herein by reference.

### SUMMARY

In general, in one aspect, the invention features an apparatus for depositing films on a substrate. The apparatus includes: a plasma deposition chamber having an input window and an output window and also having a first electrode and a second electrode that defines a target plane in which the substrate is held during deposition, and wherein during deposition a plasma is sustained between the first and second electrodes; and a monitoring system which includes a light source and an optical detector, both located outside of the deposition chamber. The optical monitoring system further includes an optical system that directs a beam from the light source through the input window and into the deposition chamber as a measurement beam, wherein the measurement beam arrives at the target plane along a path that is approximately normal to the target plane and wherein during operation the measurement beam interacts with the substrate to generate a return measurement beam that passes from the substrate out of the chamber through the output window, wherein the optical system directs the measurement return beam onto the optical detector.

Other embodiments include one or more of the following features. The light source is a laser, e.g., a tunable laser. The plasma deposition chamber is a PECVD chamber, wherein the first electrode is a showerhead through which process gases are introduced into the chamber during operation to form a film on a surface of the substrate. The second electrode has a hole extending therethrough, wherein the hole is located in the second electrode behind a position in which the substrate is held during operation. The input window is located behind the second electrode so that the measurement beam passing through the input window passes through the hole and impinges on the backside of the substrate. In some embodiments, the input window and the output window are located on the same side of the second electrode and the measurement return beam is a reflected beam produced by the measurement beam interacting with the substrate. In some of those embodiments, the input window is the output window. In other embodiments, the output and input windows are located on opposite sides of the second electrode and the measurement return beam is a transmitted beam produced by the measurement beam interacting with the substrate.

In still other embodiments, the optical monitoring system further includes a coupler that splits a beam from the light source into first and second beams that are spaced apart, wherein the optical system directs the first beam into the deposition chamber as the measurement beam and the second beam into the chamber as a reference beam. The optical monitoring system also includes a second detector located outside of the deposition chamber and wherein during operation the reference beam produces within the chamber a reference return beam that passes out of the output window, and the optical system directs the reference return beam onto the second detector. In some of the embodiments, the optical system includes a second detector and an optical splitter that splits the beam from the light source into first and second beams, wherein the optical system directs the first beam into the deposition chamber as the measurement beam and the second beam onto the second detector. The monitoring system further includes a second light source and the optical system directs light from the second light source through the input window into the deposition chamber as a reference beam that is spaced apart from the measurement beam. The monitoring system also includes a second detector located outside of the deposition chamber and wherein during operation the reference beam produces within the chamber a reference return beam that passes out of the output window, and wherein said optical system directs the reference return beam onto the second detector.

In general, in another aspect, the invention features a method of monitoring film thickness on a substrate during deposition. The method includes: in a plasma deposition chamber, plasma depositing a film onto a surface of the substrate; while the film is being deposited, introducing a measurement beam into the deposition chamber from outside of the deposition chamber; delivering the measurement beam to the substrate from a direction that is approximately normal to said surface of the substrate; interacting the measurement beam with the substrate to generate a measurement return beam; delivering the measurement return beam to outside of the deposition chamber; and detecting the measurement return beam that has exited from the deposition chamber.

Other embodiments include one or more of the following features. Plasma depositing also involves introducing a process gas into the plasma and forming the film from the process gas. Interacting the measurement beam with the substrate involves reflecting the measurement beam off of the substrate. Introducing the measurement beam into the deposition chamber involves passing the measurement beam through an input window in the plasma deposition chamber. Delivering the measurement return beam to outside of the plasma deposition chamber involves passing the measurement return beam through an output window in the plasma deposition chamber. The output window is the input window. The method also includes: while the film is being deposited, introducing a reference beam into the deposition chamber from outside of the chamber, the reference beam being spaced apart from the measurement beam inside of the chamber; providing a reference inside of the chamber; interacting the reference beam with the reference to generate a reference return beam; delivering the reference return beam to outside of the deposition chamber; and detecting the reference return beam that has exited from the deposition chamber. The reference is a mirror and wherein interacting the reference beam with the reference involves reflecting the reference beam off of the mirror to generate the reference return beam. The method also involves using the detected reference return beam to compensate for fluctuations in the detected measurement beam due to fluctuations in the measurement beam. The method also involves using both the detected measurement return beam and the detected reference return beam to determine thickness of the film as it is being deposited, wherein the detected reference return beam is used to compensate for changes in detected measurement beam that are due to changes in the measurement beam.

Other embodiments may also include one or more of the following features. The reference is a thermally tunable optical filter, and the method further involves using the detected reference return beam to compensate for changes in the detected measurement beam due to changes in temperature of the substrate. Interacting the reference beam with the reference involves reflecting the reference beam off of the thermally tunable optical filter to generate the reference return beam. The reference is a thermally tunable optical filter and the method further involves using both the detected measurement return beam and the detected reference return beam to determine thickness of the film as it is being deposited, wherein the detected reference return beam is used to compensate for changes in the detected measurement beam that are due to changes in temperature of the substrate. The method further includes putting the reference into thermal contact with the substrate. Putting the reference into thermal contact with the substrate involves resting the reference against the backside of the substrate.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates a PECVD reactor with an in-situ monitoring system.

FIG. 2 illustrates an embodiment of a monitoring system for monitoring film growth on a wafer.

FIG. 3 illustrates a second embodiment of a monitoring system for monitoring film growth on a wafer.

FIG. 4 illustrates how interference fringes shift with temperature changes.

FIG. 5 illustrates one way that data are generated from the signals coming from the in-situ monitoring system.

FIG. 6 illustrates how the monitored reference signal changes as a function of temperature.

FIG. 7 illustrates how thermal noise is removed from the monitored signal.

### DETAILED DESCRIPTION

The family of in-situ monitoring systems described below enables precise measurements of thin film growth, especially of optical thicknesses of deposited films, and aids in the deposition of multi-layered optical structures, including multicavity Fabry-Perot optical filters. Deployable in Plasma Enhanced Chemical Vapor Deposition (PECVD) reactors, the in-situ monitoring systems leave the geometry of the growth space, including the plasma gap spacing, unchanged. The optical signals for monitoring the thin-film growth are sourced and collected outside of the chamber, and both transmission and reflection monitoring configurations are possible. Systems and methods using remote measurements for compensating for a variety of noise sources, including mechanical jitter, power drift in the system lasers, and temperature drift in the chamber, are presented. Finally, various approaches to signal processing are described.

I. Beam Architecture

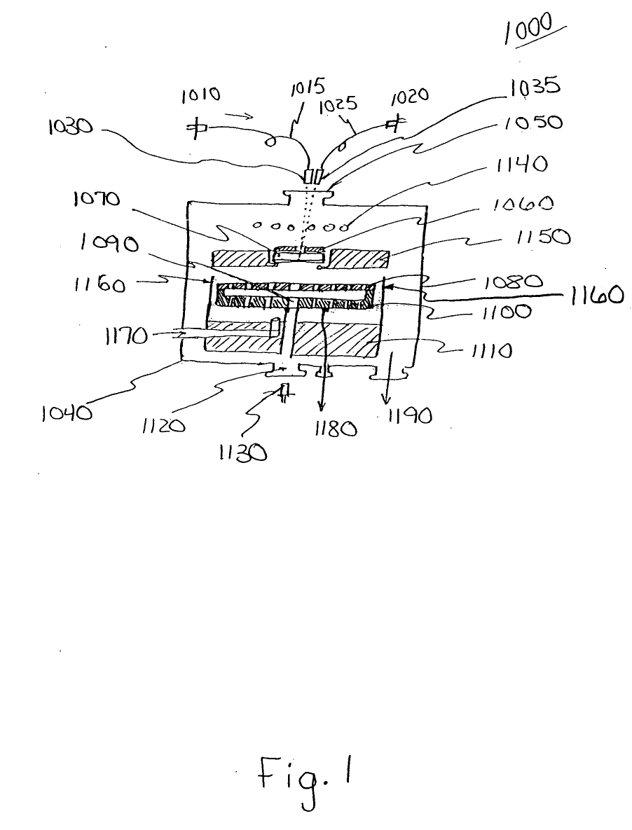

Referring to FIG. 1, one embodiment of a PECVD reactor with an in-situ monitoring system is depicted generally at 1000. Many of the optical components of monitoring system 1000 are external to reactor chamber 1040. An optical signal is introduced into chamber 1040 through port window 1050. The signal then passes through a via hole on backplate 1060 of substrate 1070, interacts with substrate 1070, and is detected. By monitoring this optical signal, information concerning wafer and thin-film properties, including film thickness, is obtained.

In this embodiment, part of the optical signal is reflected off of substrate 1070, and part is transmitted through it, so detectors can be placed to monitor either the transmitted or reflected component. In the reflection-monitoring configuration, the optical signal, originating with laser 1010, passes through fiber optic 1015 and collimator optic 1030, enters chamber 1040 through window 1050, interacts with substrate wafer 1070, and then exits back through window 1050. Upon exiting, the signal passes through collimator optic 1035, passes through fiber optic 1025, and impinges upon detector 1020. In the transmission-monitoring configuration, the optical signal enters chamber 1040, passes through the via in backplate 1060, interacts with substrate wafer 1070, and afterwards continues through a hole in upper showerhead electrode 1080, through window 1090 in bottom showerhead plate 1100, passes through a via in plenum 1110, and exits through port window 1120 to be detected by detector 1130.

Other elements of the PECVD reactor are standard and known to those skilled in the art. Halogen lamps 1140 heat the substrate, which is held by the substrate holder 1150. Holder 1150, which is made of titanium to have a thermal coefficient of expansion similar to that of silicon wafers, has a lip upon which substrate wafer 1070 sits. Clips (not shown) serve to fix wafer 1070 and backplate 1060 in place. Holder 1150, which also serves as one of the plasma electrodes, is grounded. The other electrode, spaced about one inch away in the illustrated embodiment, is upper showerhead electrode 1080, which is electrified by an electrical connection passing through electrical port 1180. Plasma confinement wall 1160, which confines the plasma to between the two electrodes, is adjustable to adjust the rate of gas flow out of the space between the two electrodes. This adjustability is achieved by threading the inside of plasma wall 1160 and the exterior of plenum 1110, and by screwing or unscrewing wall 1160 onto plenum 1110 as needed. The gas enters the space between the two electrodes through gas inlet 1170 and then passes through the holes in bottom showerhead plate 1100 and upper showerhead electrode 1080. Chamber 1040 is evacuated by a vacuum pump connected at vacuum port 1190.

II. Compensating for Drift in the Laser Signal

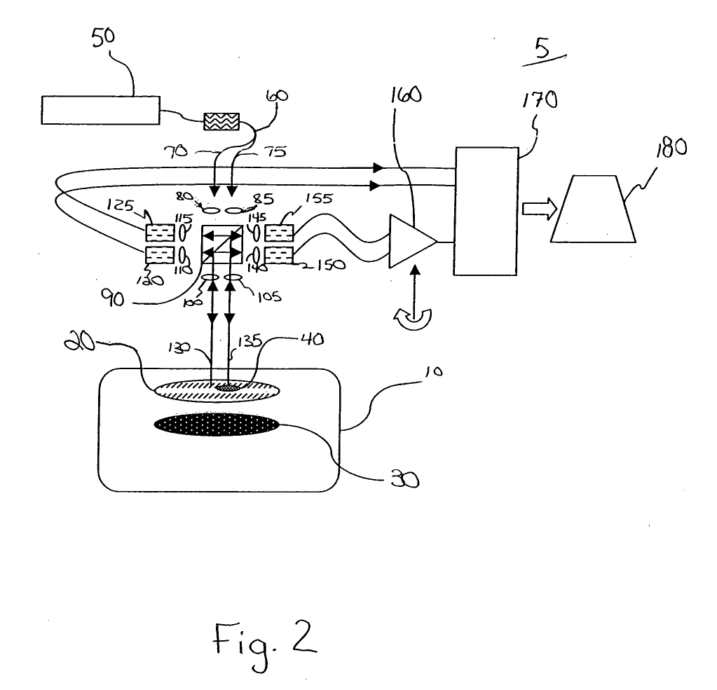

Referring to FIG. 2, one embodiment of the in-situ monitoring system, generally indicated at 5, uses a second beam as a reference to improve the measurement precision of the beam that interacts with the substrate. As seen in FIG. 2, PECVD reactor chamber 10 contains a target wafer 20, held in a substrate holder (not shown) that serves as one of the plasma-forming electrodes, and a showerhead structure 30 that serves as the other plasma-forming electrode. Primary beam 130 interacts with wafer 20 itself. The second, reference beam 135 is reflected off mirror 40, which is resting on the backside of substrate wafer 20. Beam 135 enters and exits chamber 10, and is detected in a similar fashion, as beam 130. Using a dual beam architecture and beam splitters, system 5 can compensate for power drift in the laser or for changes in the intensity of the laser beam due to mechanical vibration.

In this embodiment, no backing plates are used with the silicon wafer, as silicon has a high enough thermal conductivity to not make these necessary to achieve the required uniformity of temperature over the silicon substrate. If the target wafer is not sufficiently thermally conductive, as with glass wafers, for example, a silicon wafer is used as a backplate to achieve the required uniformity. Such silicon wafer backplates are coated with an anti-reflection coating, such as silicon nitride ¼ of a wavelength thick, to decrease any interference fringe effect.

There are clips (not shown) that hold wafer 20 in the wafer holder. One of these clips also holds monitoring mirror 40 onto wafer 20. Mirror 40 is reflective at the monitoring wavelength of 1550 nm. In the described embodiment, mirror 40 is ¼ the size of wafer 20, though it could be larger or smaller than this.

Exterior to chamber 10 is tunable laser 50, which has a center wavelength of 1550 nm and a tuning range of ±50 nm. Laser 50 is tuned during deposition when obtaining data regarding film growth. Laser 50 sends a laser beam to coupler 60, which splits the beam into two beams of equal intensity and couples those beams into corresponding fiber optics 70 and 75.

The beam exiting fiber optic 70 passes through collimator lens 80 and into beam splitter 90. Beam splitter 90 sends half of the beam into collimating optic 100, which then directs beam 130 into chamber 10. Beam splitter 90 sends the other half of the beam into optic 110 and photodetector 120.

Beam 130 enters chamber 10 through a window (not shown), passes through silicon wafer 20, and a portion of it is reflected by the thin films that are being deposited on the front of the wafer. The reflected beam passes back through optic 100, and a portion of it is reflected into optic 140, which focuses it onto photodetector 150.

The beam exiting fiber optic 75 passes through collimator 85 and into beam splitter 90. Beam splitter 90 sends half of that beam into collimating optic 105, which then directs beam 135 into chamber 10. Beam splitter 90 sends the other half of the beam into optic 115 and photodetector 125.

Beam 135, after leaving optic 105, enters chamber 10 through the same window as beam 130. Beam 135 strikes mirror 40, is reflected, passes back through optic 105, and is partially reflected into optic 145, which focuses it onto photodetector 155. The signals acquired by photodetectors 150 and 155 are differenced by differential amplifier 160, and then fed into data acquisition hardware (“DAQ”) 170 along with signals from compensation photodetectors 120 and 125. Computer 180 acquires data from DAQ 170.

Two sources of beam intensity fluctuations can contaminate the data derived from the signal detected by photodetector 150, namely, differential mode fluctuations, e.g., changes in coupler 60 that cause it to split the beam unevenly over time, and common mode fluctuations, e.g., power drift in the tunable laser 50. Data derived from compensation photodetectors 120 and 125 are used to compensate for differential mode fluctuations changes, whereas differencing of the two signals from photodetectors 150 and 155 compensates for the common mode fluctuations.

III. Compensating for Drift in Temperature

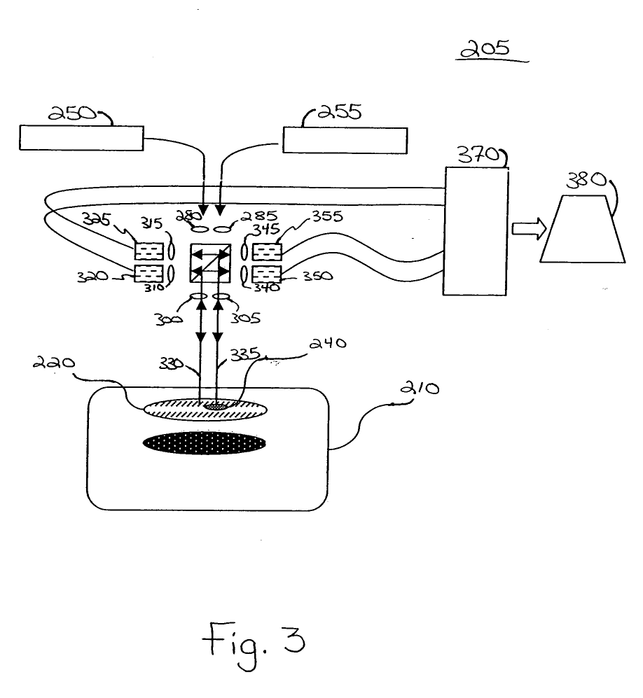

Referring to FIG. 3, another embodiment of the in-situ monitoring system, generally indicated at 205, uses a second beam to produce a reference signal to compensate for changes in the measurement signal due to shifts in temperature. In this embodiment, the second beam is generated by a second, separately controllable laser and, instead of using a mirror resting on the backside of the silicon wafer, it uses a thermally tunable thin-film optical filter.

As seen in FIG. 3, PECVD chamber 210 contains a target wafer 220. In this embodiment, reference filter 240 rests on the backside of wafer 220. Filter 240 is a thermo-optically tunable thin-film optical interference filter fabricated as described in detail in U.S. Ser. No. 10/174,503, filed Jun. 17, 2002, and U.S. Ser. No. 10/211,970, filed Aug. 2, 2002, both of which are incorporated herein by reference. The thermo-optically tunable filter 240 has a transmission pass band that is centered at a wavelength that varies as a function of temperature. Thus, the location of the pass band is an accurate indicator of temperature. Filter 240 rests on the backside of the silicon wafer and thus will be at the same temperature as wafer 220. Filter 240 is ¼ the size of wafer 220.

Exterior to chamber 210 are two independently tunable lasers 250 and 255, which each have a center wavelength of 1550 nm and a tuning range of ±50 nm. Lasers 250 and 255 are independently tuned during operation of the monitoring system to obtain data concerning film growth and deposition conditions as deposition occurs. Laser 250 emits a beam, which passes through collimator 280 and enters beam splitter 290 to be split into a first and second part. The first part of the beam passes through optic 310, which focus it onto photodetector 320. The second part of the beam passes through collimating optic 300 and through a window into chamber 210 as beam 330. Laser 255 emits a beam, which passes through collimator 285 and enters beam splitter 290 to be split into a first and second part as well. The first part passes through optic 315, which focuses it onto photodetector 325. The second part of the beam passes through collimating optic 305 and through the window into chamber 210 as beam 335.

Beam 330, after entering chamber 210, passes through silicon wafer 220, and a portion of it is reflected by the thin films that are being deposited on the front of the wafer. The reflected beam passes back through optic 300, and a portion of it is reflected into optic 340, which focuses it into photodetector 350. Beam 335, after entering chamber 210, passes through filter 240, and a portion of it is reflected by filter 240. The reflected beam passes back through optic 305, and a portion of it is reflected into optic 345, which focuses it onto photodetector 355. Data from photodetectors 320, 325, 350, and 355 pass through DAQ 370 to computer 380 for processing, as discussed below.

Beam 330 produces a measurement signal that is used to monitor the thickness of the thin film being deposited. Beam 335 produces a reference signal that is used to measure the temperature of the silicon wafer. Since the reflectivity of the stack of thin films that are being deposited will also vary with temperature, knowing the actual temperature fluctuations enables one to compensate for that effect. In other words, knowing the actual temperature fluctuation of the wafer enables one to remove the temperature effect from the measurement signal. Thus, the signal processing software uses the information derived from beam 335 to reduce the impact of variations in temperature on the thin film thickness measurements.

Data derived from the signals produced by compensation photodetectors 320 and 325 are used to compensate for power drifting in lasers 250 and 255, as previously described.

IV. Signal Processing Algorithms

Beam 130 in FIG. 2 and beam 330 in FIG. 3 are focused on the wafer to be monitored. The data collected by photodetectors 150 in FIGS. 2 and 350 in FIG. 3 are compensated for power drift of the laser. After compensation, these data are used to indicate the thickness that the film growth has achieved on the substrate and underlying thin films.

In reflection-monitoring configurations a portion of the measurement beam will also reflect off of the backside of the wafer and will interfere with the beam that reflects off of the front side of the wafer when the thin films are being deposited. These two reflected beams will interfere and that interference will change as the temperature of the wafer changes. This is largely because the wafer thickness will expand or contract, thereby changing the size of the reflection cavity produced by the front and backsides of the wafer. This interference has much greater effect in reflection-monitoring configurations than in transmission-monitoring configurations. There are a number of ways to minimize the impact of these changes on the measurements; some of these ways will now be discussed.

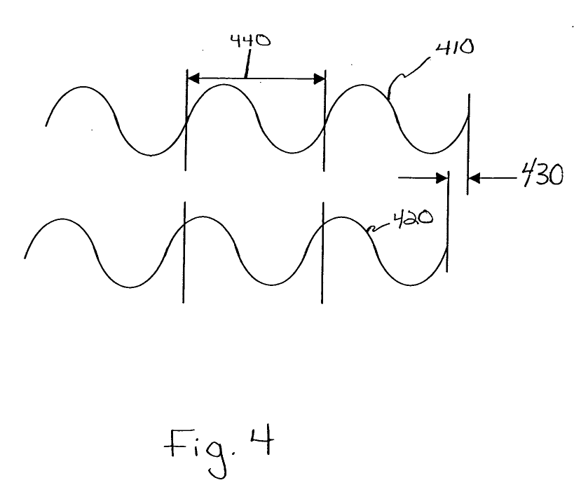

Referring to FIG. 4, interference signal 410 results when the wavelength of the laser is changed. When the temperature changes, interference signal 410 shifts left by an amount 430 to produce interference signal 420. To eliminate the effect of this fringe and its drift, laser 50 in FIG. 2 and laser 250 in FIG. 3 are swept (i.e., tuned) over a range 440 approximately equally to one or more fringes. The average value of the detected signal is free of the fringe effect.

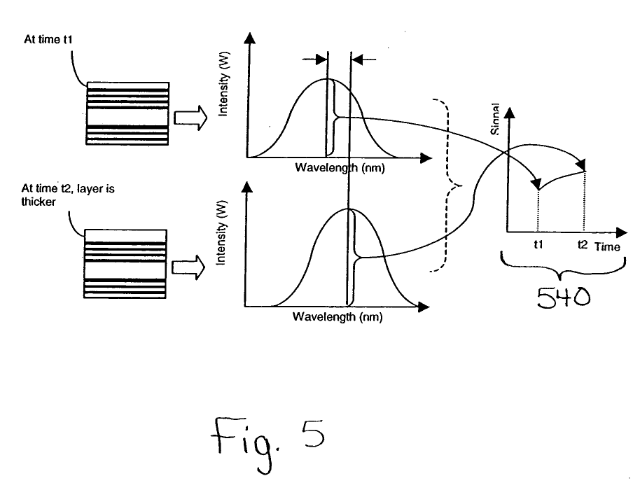

Another signal processing approach that helps reduce the temperature effect is illustrated in FIG. 5. As the thin film is being deposited on an existing filter structure the amplitude of the bandpass curve will change. This change is a measure of the thickness of the film being deposited. Unfortunately, changes in temperature will produce shifts in the location of the peak and thus will also cause a change in the measured signal. By tuning the measurement laser over a range that locates the peak of the bandpass curve, the amplitude of the peak can be determined regardless of where it has shifted. Thus, by measuring the amplitude of the peak, the effects attributable to the shifting of the curve are eliminated. The maximum value of the spectrum (i.e., the maximum intensity value) is recorded and plotted on time signal graph 540. Note that any shift in wavelength of the spectrum does not affect the plot in graph 540. Graph 540 displays the change in signal intensity over time attributable only to changes in the thickness of the film being deposited on the substrate. Note also that interference fringes arising from the substrate wafer itself will be superimposed on the passband curve. If the substrate wafer is thick, the distance between fringes will be short compared to the size of the passband, and tuning the laser over the passband range will result in high-frequency noise that can be filtered out by using of a low-frequency signal amplifier that does not see the high frequencies caused by the interference signal.

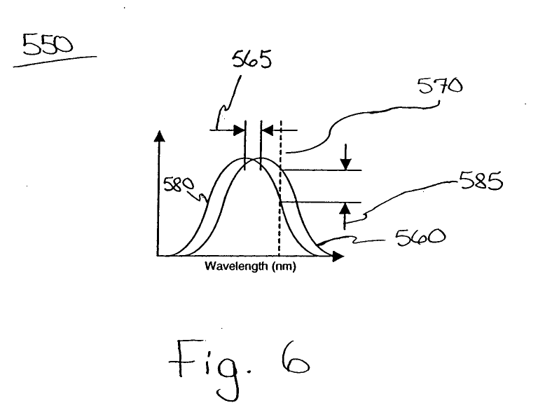

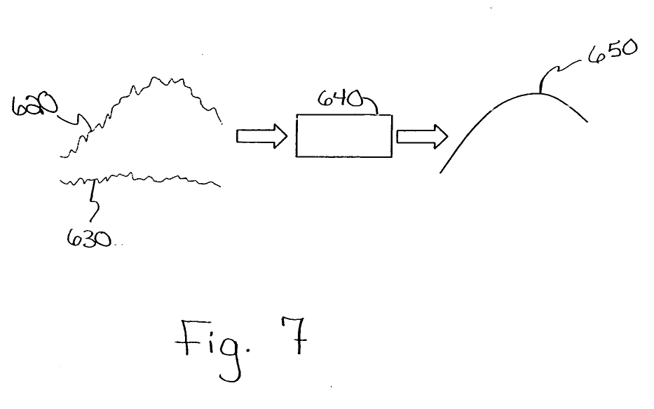

More precise temperature data can be obtained and be used to reduce noise in the thickness data by use of the tuning capability of laser 255. Referring to FIG. 3, reference laser 255 is swept over the wavelength range of the passband of filter 240 to determine the central wavelength of filter 240. Referring to FIG. 6, this passband is represented generally in graph 550 as the plot 560. As the temperature of wafer changes, the passband shifts, for example, to the left as illustrated by plot 580. This results in a displacement of the central wavelength by an amount 565. During film growth, the laser frequency sweeping continues and the change in the central wavelength is tracked, measuring the variations in temperature. By relying on the known properties of filter 240 (e.g., the location of the center of the passband as a function of temperature), the precise change in the temperature and the absolute temperature of wafer 220 is known. Referring to FIG. 7, the effects of these variations upon the wafer monitoring beam can then be determined, as shown by plot 630, and then removed by signal processing 640, resulting in processed data 650 useful in monitoring the fabrication of thin films. Processing 640 can be subtracting plot 630 from plot 620, or include more complicated mathematical operations.

There is another approach to obtaining precise temperature data using the second beam architecture. Referring again to FIG. 3, laser 255 is swept over the passband of filter 240 to determine the central wavelength of filter 240 and the shape of the passband. Referring to FIG. 6, this passband is represented generally in graph 550 as the plot 560. Then the laser is tuned to and fixed at wavelength 570 at the edge of the passband. As the temperature drifts and the passband shifts left as demonstrated by plot 580, the signal reflected by filter 240 changes, resulting in a signal difference 585.

By monitoring the strength of the signal reflected by filter 240, the direction and magnitude of the shift in the position of the central wavelength is known, and the effects of the temperature variations of the wafer can then be subtracted out of the signal collected by photodetector 350. This accurate temperature information is acquired without any physical contact of the wafer 220.

In employing the third or fourth monitoring method to collect data containing information regarding temperature, algorithms can be used to further reduce temperature-related noise in the signal detected by photodetector 350 of FIG. 3. Referring to FIG. 7, raw data from photodetector 350 can be represented by plot 620. Raw data from photodetector 355 are represented by plot 630. Data 620 have some noise due to the unstable temperature in chamber 210. Data 630 contain information about the temperature fluctuation, but data 630 also are correlated to the noise in data 620 because filter 240 is thermally sensitive. Exploiting this correlation, the temperature noise in the processed signal 650 is reduced by signal processing 640 to remove these effects, resulting in processed data 650 useful in monitoring the fabrication of thin films. Processing 640 can be subtracting plot 630 from plot 620, or include more complicated mathematical operations.

The dual beam architecture and the signal processing techniques can also be used in transmission mode in-situ monitoring systems.

The equipment and methods described herein are particularly well suited for fabricating the thermo-optically tunable thin film optical filters described in U.S. Ser. No. 10/174,503, filed Jun. 17, 2002, and U.S. Ser. No. 10/211,970, filed Aug. 2, 2002. When used to fabricate those filters, the reference used in the approach of FIG. 3 can be a thermo-optically tunable filter of the very same type that is being fabricated. Thus, its characteristics and response to temperature variations will be very similar to that of the filter being fabricated. In addition, because the filters have transmission/reflection characteristics that very substantially with temperature, the monitoring wavelength should be selected to be located relative to where the passband is located at the higher fabrication temperatures. For example, if substrate is at 200 C, then that means the passband will have shifted by a substantial amount from where it is located at room temperature. Thus, the wavelengths of the measurement beam and the reference beam should be shifted accordingly so that they are located either at the edge of the passband or at its center, whichever is appropriate for the signal processing technique that is being used.

It should also be understood that the monitoring approaches and various of signal processing approaches can be used in combination within the same system.

What is claimed is:

1. An apparatus for depositing films on a substrate, said apparatus comprising:
a plasma deposition chamber having a first electrode and a second electrode that defines a target plane in which the substrate is held during deposition, and wherein during deposition a plasma is sustained between the first and second electrodes, said deposition chamber also including an input window and an output window; and
a monitoring system which includes a light source and an optical detector, both located outside of the deposition chamber, said optical monitoring system also including an optical system that directs a beam from the light source through the input window and into the deposition chamber as a measurement beam, wherein the measurement beam arrives at the target plane along a path that is approximately normal to the target plane and wherein during operation said measurement beam interacts with the substrate to generate a return measurement beam that passes from the substrate out of the chamber through the output window, wherein said optical system directs the measurement return beam onto the optical detector.

2. The apparatus of claim 1, wherein the light source is a laser.

3. The apparatus of claim 2, wherein the laser is a tunable laser.

4. The apparatus of claim 2, wherein the plasma deposition chamber is a PECVD chamber and wherein the first electrode is a showerhead through which process gases are introduced into the chamber during operation to form a film on a surface of the substrate.

5. The apparatus of claim 4, wherein the second electrode has a hole extending therethrough, said hole located in the second electrode behind a position in which the substrate is held during operation, wherein the input window is located behind the second electrode so that the measurement beam passing through the input window passes through the hole and impinges on the backside of the substrate.

6. The apparatus of claim 5, wherein the input window and the output window are located on the same side of the second electrode and wherein the measurement return beam is a reflected beam produced by the measurement beam interacting with the substrate.

7. The apparatus of claim 6, wherein the input window is the output window.

8. The apparatus of claim 5, wherein the output and input windows are located on opposite sides of the second electrode and the measurement return beam is a transmitted beam produced by the measurement beam interacting with the substrate.

9. The apparatus of claim 4, wherein the optical monitoring system further comprises a coupler that splits a beam from the light source into first and second beams that are spaced apart, wherein the optical system directs the first beam into the deposition chamber as the measurement beam and the second beam into the chamber as a reference beam.

10. The apparatus of claim 9, wherein the optical monitoring system also includes a second detector located outside of the deposition chamber and wherein during operation the reference beam produces within the chamber a reference return beam that passes out of the output window, and wherein said optical system directs the reference return beam onto the second detector.

11. The apparatus of claim 4, wherein the optical system also includes a second detector and an optical splitter that splits the beam from the light source into first and second beams, wherein the optical system directs the first beam into the deposition chamber as the measurement beam and the second beam onto the second detector.

12. The apparatus of claim 4, wherein the monitoring system includes a second light source and wherein the optical system directs light from the second light source through the input window into the deposition chamber as a reference beam that is spaced apart from the measurement beam.

13. The apparatus of claim 12, wherein the monitoring system also includes a second detector located outside of the deposition chamber and wherein during operation the reference beam produces within the chamber a reference return beam that passes out of the output window, and wherein said optical system directs the reference return beam onto the second detector.

14. A method of monitoring film thickness on a substrate during deposition, said method comprising:
in a plasma deposition chamber, plasma depositing a film onto a surface of the substrate;
while the film is being deposited, introducing a measurement beam into the deposition chamber from outside of the deposition chamber;
delivering the measurement beam to the substrate from a direction that is approximately normal to said surface of the substrate;
interacting the measurement beam with the substrate to generate a measurement return beam;
delivering the measurement return beam to outside of the deposition chamber; and
detecting the measurement return beam that has exited from the deposition chamber.

15. The method of claim 14, wherein plasma depositing also comprises introducing a process gas into the plasma and forming the film from the process gas.

16. The method of claim 15, wherein interacting the measurement beam with substrate involves reflecting the measurement beam off of the substrate.

17. The method of claim 15, wherein introducing the measurement beam into the deposition chamber involves passing the measurement beam through an input window in the plasma deposition chamber

18. The method of claim 17, wherein delivering the measurement return beam to outside of the plasma deposition chamber involves passing the measurement return beam through an output window in the plasma deposition chamber.

19. The method of claim 18, wherein the output window is the input window.

20. The method of claim 15, further comprising:
while the film is being deposited, introducing a reference beam into the deposition chamber from outside of the chamber, said reference beam being spaced apart from the measurement beam inside of the chamber;
providing a reference inside of the chamber;
interacting the reference beam with the reference to generate a reference return beam;
delivering the reference return beam to outside of the deposition chamber; and
detecting the reference return beam that has exited from the deposition chamber.

21. The method of claim 20, wherein the reference is a mirror and wherein interacting the reference beam with the reference involves reflecting the reference beam off of the mirror to generate the reference return beam.

22. The method of claim 21, further comprising using the detected reference return beam to compensate for fluctuations in the detected measurement beam due to fluctuations in the measurement beam.

23. The method of claim 21, further comprising using both the detected measurement return beam and the detected reference return beam to determine thickness of the film as it is being deposited, wherein the detected reference return beam is used to compensate for changes in detected measurement beam that are due to changes in the measurement beam.

24. The method of claim 20, wherein the reference is a thermally tunable optical filter, said method further comprising using the detected reference return beam to compensate for changes in the detected measurement beam due to changes in temperature of the substrate.

25. The method of claim 24, wherein interacting the reference beam with the reference involves reflecting the reference beam off of the thermally tunable optical filter to generate the reference return beam.

26. The method of claim 20, wherein the reference is a thermally tunable optical filter, said method further comprising using using both the detected measurement return beam and the detected reference return beam to determine thickness of the film as it is being deposited, wherein the detected reference return beam is used to compensate for changes in the detected measurement beam that are due to changes in temperature of the substrate.

27. The method of claim 20, further comprising putting the reference into thermal contact with the substrate.

28. The method of claim 27, wherein putting the reference into thermal contact with the substrate involves resting the reference against the backside of the substrate.
